(19) United States
(12) Patent Application Publication
(10) Pub. No.: US 2015/0318017 A1
(43) Pub. Date: Nov. 5, 2015

(54) METHOD FOR CLEANING GLASS SUBSTRATE

(71) Applicant: KAO CORPORATION, Chuo-ku, Tokyo (JP)

(72) Inventors: Nobuyuki AONO, Wakayama-shi (JP); Jun NAGANUMA, Wakayama-shi (JP); Sadaharu MIYAMOTO, Wakayama-shi (JP)

(73) Assignee: KAO CORPORATION, Tokyo (JP)

(21) Appl. No.: 14/649,802

(22) PCT Filed: Dec. 3, 2013
(86) PCT No.: PCT/JP2013/082468

§ 371 Date: Jun. 4, 2015

(30) Foreign Application Priority Data
Dec. 5, 2012 (JP) 2012-266334

(51) Int. Cl. G11B 23/50; C11D 3/04; C11D 1/02; C11D 1/72; C11D 11/00; C11D 3/30; C11D 3/28

(52) U.S. Cl. CPC G11B 23/505; C11D 3/30; C11D 3/04; C11D 3/28; C11D 1/72; C11D 11/0035; C11D 1/02

(57) ABSTRACT

To provide a method for cleaning a glass substrate in which aggravation of surface roughness of the glass substrate in alkali cleaning is suppressed and cleaning performance is improved. In one or a plurality of embodiments, this invention relates to a method for cleaning a glass substrate, including bringing a detergent composition into contact with a glass substrate to be cleaned. The detergent composition containing an amine including 1 to 10 nitrogen atoms and an inorganic alkali, the amine content is in a range of 5.00 mass % to 70.00 mass % relative to the total mass of components of the detergent composition other than water, the glass substrate to be cleaned is a crystallized glass substrate, and a pH of the detergent composition during cleaning is in a range of 9.00 to 11.50.

### TECHNICAL FIELD

The present invention relates to a method for cleaning a glass substrate, and a method for producing a glass hard disk substrate.

### BACKGROUND ART

Recently, personal computers and various electronic devices come to handle massive data such as moving images and audios, which requires information recording devices of large capacities. As a result, year by year, information recording media are required to have higher information packing densities. To deal with such a demand, there has been a trend for employment of a vertical magnetic recording system for a hard disk and also a volume production thereof. In this vertical magnetic recording system, a substrate for an information recording medium (hereinafter, this is referred to also as “hard disk substrate”) is required to have a higher level of heat resistance and surface smoothness in comparison with the existing substrates. In addition to that, a higher emphasis is placed on decrease in specific gravity for reducing the load on the spindle motor, and having a high mechanical strength for preventing the disk from crashing and a high fracture toughness to resist bump against a head at the time of fall.

Examples of the material used for a substrate of an information recording medium include aluminum alloy, glass and the like. The glass is superior to the aluminum alloy from the viewpoint of a higher Vickers hardness, higher surface smoothness and the like, and thus, it is used widely in the field expecting dynamic application.

Among glasses used for substrates for information recording media, crystallized glass has advantages, for example, excellent heat resistance, high impact resistance, high drop strength due to the high impact resistance, head-crash proof because of its high rigidity to prevent flaws, and the substrate rarely sags during a high revolution. Due to such advantages, a crystallized glass substrate is prospected as a material for an information recording medium for realizing higher information packing densities.

JP 2007-223884 discloses an inorganic composition where the value of its surface roughness change rate (|Ra2−Ra1|/Ra1) is less than 0.62 when Ra1 is a surface roughness after polishing and Ra2 is a surface roughness obtained by acid cleaning and/or alkali cleaning after a polishing process. The reference discloses also that the inorganic composition is a crystallized glass and it is used as a substrate for producing a magnetic disk. In the Examples, cleaning with hydrofluoric acid is disclosed.

JP 2010-257510 discloses a detergent composition for a hard disk substrate having an Ni—P layer. The detergent composition contains an amine and an alkali. JP 2012-107226 discloses a method for producing a glass hard disk substrate. The producing method includes a step of polishing a glass substrate to be polished by use of a polishing liquid composition having a pH in a range of 1.0 to 4.2 containing a polyvalent amine compound having 2 to 10 nitrogen atoms in the molecule and a step of cleaning by use of a detergent composition having a pH in a range of 8.0 to 13.0. It is disclosed that in the producing method, aggravation of the surface roughness during the alkali cleaning step is suppressed. JP 2009-206481 discloses a detergent for electronic materials (for glass). The detergent contains an anionic surfactant, an organic solvent and an alkali component. It is disclosed that the detergent is capable of providing an excellent performance in removal of particles without sacrificing the surface flatness. Examples of the alkali component include C1-C36 aliphatic amines, inorganic alkali, C1-C23 alkanolamines, and C4-C10 amidine compounds.

### DISCLOSURE OF INVENTION

### Problem to be Solved by the Invention

From the viewpoint of cleaning of particles such as polishing particles, it is preferable that a glass substrate is cleaned under an alkaline condition. However, it causes a problem, i.e., when a glass substrate is cleaned under an alkaline condition, the surface of the glass substrate is etched to degrade the surface smoothness. Moreover, a crystallized glass, in particular, a crystallized glass for a hard disk substrate has an amorphous part as well as a crystallized part, and thus it is not a homogeneous material. Therefore, at the time of cleaning the substrate with alkali, the difference in etching performance (solubility) at the crystallized part and at the amorphous part will makes it further difficult to clean without aggravating the surface roughness.

Therefore in one aspect, the present disclosure provides a method for cleaning a crystallized glass substrate for the purpose of suppressing aggravation of surface roughness of a crystallized glass substrate during an alkali cleaning, in particular, cleaning of the polishing particles such as remaining silica particles, and further capable of improving the cleaning performance.

### Means for Solving Problem

In one aspect, the present invention relates to a method for cleaning a glass substrate, including bringing a detergent composition into contact with a glass substrate to be cleaned (hereinafter, this is referred to also as “method for cleaning a glass substrate regarding the present disclosure). In this aspect, the detergent composition is a detergent composition containing an amine including 1 to 10 nitrogen atoms and an inorganic alkali (hereinafter, this is referred to also as a “detergent composition according to the present disclosure). The content of the amine is in a range of 5.00 mass % to 70.00 mass % relative to the total mass of components of the detergent composition other than water. The glass substrate to be cleaned is a crystallized glass substrate. A pH of the detergent composition during cleaning is in a range of 9.00 to 11.50.

In another aspect, the present invention relates to a method for producing a glass hard disk substrate, comprising steps (1) and (2) below:

step (1) of polishing a glass substrate to be polished by use of a polishing liquid composition; and

step (2) of cleaning the substrate obtained in the step (1) by use of a detergent composition.

In this aspect, the detergent composition contains an amine including 1 to 10 nitrogen atoms and an inorganic alkali. The content of the amine is in a range of 5.00 mass % to 70.00 mass % relative to the total mass of components of the detergent composition other than water. The glass substrate to be cleaned is a crystallized glass substrate. A pH of the detergent composition during cleaning is in a range of 9.00 to 11.50.

### Effects of the Invention

In one aspect, the present disclosure provides a method for cleaning a crystallized glass substrate, the method can suppress aggravation of the surface roughness of the crystallized glass substrate during an alkali cleaning, in particular a cleaning of polishing particles such as remaining silica particles, and furthermore the method can improve the cleaning performance.

### DESCRIPTION OF THE INVENTION

The present disclosure is based on a finding that if a crystallized glass substrate is cleaned by using a detergent composition that contains a predetermined amine and a predetermined amount of inorganic alkali and also has a predetermined pH, aggravation of surface roughness of the crystallized glass substrate due to alkali cleaning can be suppressed, and furthermore the cleaning performance can be improved.

Although it has not been clarified in detail why the method for cleaning a glass substrate according to the present disclosure can suppress aggravation of surface roughness caused by alkali cleaning of a crystallized glass substrate and further can improve the cleaning performance, the reason may be assumed as follows. In a crystallized glass substrate, both a crystallized part and an amorphous part exist. During an alkali cleaning, apparently it is more difficult to etch the crystallized part than the amorphous part, and thus in an ordinary and simple alkali cleaning, only the amorphous part is dissolved while the crystallized part protrudes as a convex, thereby the surface roughness aggravates. On the other hand, in the method for cleaning a glass substrate according to the present disclosure, a detergent composition containing a predetermined amine is used at a predetermined pH, and thus, the nitrogen atoms in the amine are bonded easily to the amorphous part formed mainly of SiO₂ but the nitrogen atoms are adsorbed rarely by the crystallized part formed mainly of spinel and/or gahnite and the like. It is assumed, therefore, the amine having a relatively low etching capability etches the amorphous part and the inorganic alkali having a relatively high etching capability etches the crystallized part to which the amine is less adsorbed, and thus, both the crystallized part and the amorphous part are etched equivalently, so that the aggravation of surface roughness can be suppressed and also the cleaning performance can be improved. It is considered that if an amine includes excessive nitrogen atoms, the amine has an inferior capability to etch the amorphous part, and thus the effect of suppressing aggravation of surface roughness deteriorates. However, it should be noted that the present invention is not limited to these mechanisms.

[Crystallized Glass Substrate]

In the present disclosure, the glass substrate to be cleaned as an object for cleaning and/or the glass substrate to be polished as an object for polishing is a crystallized glass substrate. In the present disclosure, a “crystallized glass substrate” refers to glass including a crystal phase in glass, and in one or a plurality of non-limited embodiments, it indicates a substrate in which a spinel-based compound and/or gahnite is used as the principal component of the crystal phase. The crystallized glass substrate is different from an amorphous glass substrate, and they can be distinguished from each other with reference to a presence/absence of peaks derived from the crystallized part, by an X-ray diffraction analysis for example. The crystallized glass can be produced for example by heating an amorphous glass of a predetermined composition thereby accelerating crystallization, though the present disclosure is not limited thereto.

In one or a plurality of embodiments, a crystallized glass substrate to be cleaned according to the present disclosure is a crystallized glass substrate that has been polished, preferably a crystallized glass substrate that has been polished with silica particles, and in one or a plurality of embodiments, it is a crystallized glass substrate that has been subjected to a polishing step in a method for producing a glass hard disk substrate (glass substrate for a hard disk). Furthermore, in one or a plurality of embodiments, a crystallized glass substrate to be cleaned according to the present disclosure is a crystallized glass substrate to be cleaned, having a crystallized glass surface that has been subjected to polishing by use of a polishing composition.

In one or a plurality of embodiments, the surface roughness Ra before cleaning of the crystallized glass substrate to be cleaned according to the present disclosure is preferably 1.70 Å or more from the viewpoint of easiness in polishing operation, and, preferably it is 2.50 Å or less, and more preferably, 2.20 Å or less, from the viewpoint of suppressing aggravation of the surface roughness after cleaning. The surface roughness Ra can be measured by the method in the below-mentioned Examples.

[Detergent Composition]

In one aspect, the detergent composition according to the present disclosure contains an amine including 1 to 10 nitrogen atoms and an inorganic alkali. In one aspect, the detergent composition according to the present disclosure is used in a method for cleaning a crystallized glass substrate by being brought into contact with a crystallized glass substrate to be cleaned, and in another aspect, it is used for cleaning a crystallized glass substrate after a polishing step in a method for producing a crystallized glass hard disk substrate.

[pH of Detergent Composition]

A pH of the detergent composition according to the present disclosure is in a range of 9.00 to 11.50 during cleaning. Preferably it is 11.0 or less, and more preferably 10.70 or less, from the viewpoint of suppressing aggravation of the surface roughness after cleaning. From the viewpoint of improving the cleaning performance, the pH of the detergent composition according to the present disclosure is preferably 9.50 or more during cleaning, more preferably 10.00 or more, further preferably 10.50 or more, even further preferably 10.90 or more, and even further preferably 11.00 or more, and, 11.50 or less. In the present disclosure, “during cleaning” indicates, in one or a plurality of embodiments, the period for conducting a cleaning step. From the viewpoint of storage and transportation, the detergent composition is produced often as a concentrated liquid and diluted in use. Therefore in one or a plurality of embodiments, “during cleaning” according to the present disclosure refers to the diluted state. The above-mentioned pH refers to a pH at the time of using the detergent composition at 25° C., it can be measured by use of a pH meter (HM-30G manufactured by DKK-TOA CORPORATION) and indicates a numerical value taken 3 minutes after immersing an electrode in the detergent composition.

[Amine]

In one aspect, the amine contained in the detergent composition according to the present disclosure includes 1 to 10 nitrogen atoms. However, aminocarboxylic acids such as ethylenediaminetetraacetic acid are regarded as chelating agents not included in the amine including 1 to 10 nitrogen atoms. From the viewpoint of improving cleaning performance, the number of nitrogen atoms included in the amine is 10 or less, preferably 8 or less, more preferably 6 or less, further preferably 3 or less, and even further preferably 2 or less. From the viewpoint of suppressing aggravation of surface roughness after cleaning, the number of nitrogen atoms included in the amine is 1 or more, preferably 2 or more, and more preferably 5 or more, and, preferably 6 or less. In one or a plurality of embodiments, the number of nitrogen atoms in an amine is in a range of 1 to 10, 2 to 8, or 2 to 3, from the viewpoint of improving the cleaning performance while suppressing aggravation of the surface roughness.

From the viewpoint of improving the cleaning performance, the molecular weight or weight average molecular weight of the amine contained in the detergent composition according to the present disclosure is preferably 500 or less, more preferably 400 or less, further preferably 300 or less, and even further preferably 150 or less, and, preferably 50 or more, and more preferably 100 or more. It is preferably 40 or more, more preferably 50 or more, further preferably 80 or more, even further preferably 150 or more, and even further preferably 200 or more, and, preferably 300 or less, and more preferably 250 or less, from the viewpoint of suppressing aggravation of the surface roughness after cleaning. Only one kind of amine or plural kinds of amines may be contained in the detergent composition. Further, the amine may be in the form of salt, and the examples include salts of inorganic acids such as hydrochloric acid, sulfuric acid, phosphoric acid and the like, organic acids and the like, and anionic surfactants.

Among the amines according to the present disclosure, the molecular weight of an amine that does not have a molecular weight distribution can be calculated from a molecular formula. Regarding an amine having a molecular weight distribution, the weight average molecular weight can be measured by a gel permeation chromatography (GPC) method.

In one or a plurality of embodiments, the structure of the amine contained in the detergent composition according to the present disclosure is linear, branched, or cyclic. From the viewpoint of suppressing aggravation of the surface roughness after cleaning and from the viewpoint of improving the cleaning performance, a linear or cyclic structure is preferred, and a linear structure is further preferred. Furthermore, from a similar viewpoint, the amine may include a hydroxyl group.

Specific examples of the amines include: polyethylenepolyamines such as ethylenediamine, diethylenetriamine, triethylenetetramine, tetraethylenepentamine, pentaethylenehexamine, and the like; alkanolamines such as monoethanolamine, 2-[(2-aminoethyl)amino]ethanol, 2-[methyl[2-(dimethylamino)ethyl]amino]ethanol, 2,2′-(ethylenebisimino)bisethanol, N-(2-hydroxyethyl)-N′-(2-aminoethyl)ethylenediamine, 2,2′-(2-aminoethylimino)diethanol, N1,N4-bis(hydroxyethyl)diethylenetriamine, N1,N7-bis(hydroxyethyl)diethylenetriamine, 1,3-diamino-2-propanol, and the like; and compounds having piperazine rings such as piperazine, 1-methylpiperazine, 3-(1-piperazinyl)-1-propaneamine, 1-(2-aminoethyl)piperazine, 4-methylpiperazine-1-amine, 1-piperazinemethaneamine, 4-ethyl-1-piperazineamine, 1-methyl-4-(2-aminoethyl)piperazine, 1-(2-hydroxyethyl)piperazine, and the like, though the present disclosure is not limited thereto. For the polyethylenepolyamine, a compound represented by General Formula (I) below is preferred.

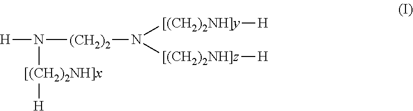

[in Formula (I), x, y and z respectively denote integers in a range of 0 to 4, satisfying 1≦x+y+z≦4].

Examples of one or a plurality of non-limited embodiments of General Formula (I) include ethylenediamine, diethylenetriamine, triethylenetetramine, and tetraethylenepentamine.

From the viewpoint of suppressing aggravation of the surface roughness after cleaning and from the viewpoint of improving the cleaning performance, the amine is preferably at least one amine selected from the compound of General Formula (I), alkanolamine, and a compound having a piperazine ring. More preferably, it is at least one amine selected from the group consisting of: tetraethylenepentamine, pentaethylenehexamine, monoethanolamine, 2-[(2-aminoethyl)amino]ethanol, and 1-(2-hydroxyethyl)piperazine. Further, from the viewpoint of suppressing aggravation of the surface roughness after cleaning, more preferably, the amine is at least one amine selected from the group consisting of: tetraethylenepentamine, pentaethylenehexamine, and 1-(2-hydroxyethyl)piperazine. From the viewpoint of improving the cleaning performance, more preferably, the amine is at least one amine selected from the group consisting of: monoethanolamine and 2-[(2-aminoethyl)amino]ethanol, and 2-[(2-aminoethyl)amino]ethanol is even further preferred.

The content of the amine contained in the detergent composition according to the present disclosure: the amine is in a range of 5.00 mass % to 70.00 mass % relative to the total mass of the components other than water. It is preferably 8.00 mass % or more, more preferably 15.70 mass % or more, and further preferably 16.5 mass % or more, and, preferably it is 50.00 mass % or less, more preferably 45.00 mass % or less, and further preferably 20.00 mass % or less, from the viewpoint of suppressing aggravation of the surface roughness after cleaning. Further, from the viewpoint of improving the cleaning performance, the content of the amine contained in the detergent composition according to the present disclosure is preferably 8.00 mass % or more, and more preferably 15.00 mass % or more, and, preferably 15.70 mass % or less relative to the total mass of the components other than water. In a case where plural kinds of amines are contained in the detergent composition, the above-described content indicates the total content of all of the amines.

[Inorganic Alkali]

Although in one aspect the inorganic alkali contained in the detergent composition according to the present disclosure is not limited particularly, from the viewpoint of improving the cleaning performance, an alkali metal hydroxide is preferred, and sodium hydroxide and/or potassium hydroxide is further preferred.

The content of the inorganic alkali contained in the detergent composition according to the present disclosure is not limited in particular as long as the pH of the crystallized glass hard disk substrate during cleaning is within the above-described range. From the viewpoint of suppressing aggravation of the surface roughness after cleaning, the amount of the alkali metal ion contained in the detergent composition according to the present disclosure is preferably 1.00 mass % or more. Preferably, it is 2.00 mass % or less, and more preferably 1.70 mass % or less. Furthermore, preferably it is 1.00 mass % or more, more preferably 1.50 mass % or more, and further preferably 1.80 mass % or more, from the viewpoint of improving the cleaning performance.

[Arbitrary Component]

The detergent composition according to the present disclosure may contain a nonionic surfactant, a solubilizer, an anionic polymer, a chelating agent, an antioxidant, an antiseptic agent and the like in addition to the amine and the inorganic alkali.

[Nonionic Surfactant]

From the viewpoint of improving the cleaning performance of the detergent composition, it is preferable that the detergent composition according to the present disclosure contains a nonionic surfactant. For the nonionic surfactant to be contained in the detergent composition of the present invention, for example, a nonionic surfactant represented by General Formula (II) below is preferred from the viewpoint of improving the cleaning performance of the detergent composition:

R—O-(EO)o(PO)p-H (II)

[in Formula (II), R is a linear or branched alkyl group having 6-16 carbon atoms, EO is an ethyleneoxy group, PO is a propyleneoxy group, o is an average number of added moles of EO, and p is an average number of added moles of PO; o is a number in a range of 0 to 20, and p is a number in a range of 0 to 5].

In the above-described General Formula (II), preferably R has 8 or more carbon atoms, and more preferably 12 or more, further preferably 14 or less. Further, R is a linear or branched alkyl group, and preferably it is linear. Further, o and p are average numbers of added moles of EO and PO respectively. From the viewpoint of improving the cleaning performance, it is preferable that o is a number of 5 or more, more preferably 8 or more, and, preferably 20 or less, and more preferably 15 or less. From the viewpoint of improving the cleaning performance, p is a number of 0 or more, preferably a number of 1 or more, and, preferably a number of 4 or less, and more preferably 3 or less.

Specific examples of the compound represented by General Formula (II) include: alcohols such as decanol, isodecyl alcohol, tridecyl alcohol, lauryl alcohol, myristyl alcohol, and the like; and compounds formed by adding an ethyleneoxy group and/or a propyleneoxy group to these alcohols. From the viewpoint of improving the cleaning performance, a compound formed by adding an ethyleneoxy group and/or a propyleneoxy group to lauryl alcohol and/or myristyl alcohol is preferred. The compound represented by General Formula (II) may be used singly or as a mixture of two or more.

From the viewpoint of suppressing aggravation of the surface roughness after cleaning, the content of the nonionic surfactant in the detergent composition according to the present disclosure is preferably 1.00 mass % or more, more preferably 3.95 mass % or more, and further preferably 4.20 mass % or more, and, preferably 5.00 mass % or less, and more preferably 4.35 mass % or less relative to the total mass of the components other than water. From the viewpoint of improving the cleaning performance, the content of the nonionic surfactant is preferably 1.00 mass % or more, more preferably 1.50 mass % or more, and further preferably 3.00 mass % or more, and, preferably 5.00 mass % or less, and more preferably 3.95 mass % or less.

[Solubilizer]

From the viewpoint of improving the preservation stability of the detergent composition, it is preferable that the detergent composition according to the present disclosure contains at least one solubilizer selected from the group consisting of: organic sulfonic acids such as p-toluenesulfonic acid, dimethylbenzenesulfonic acid, and the like; 2-ethylhexanoic acid; and salts thereof. From the viewpoint of improving the preservation stability of the detergent composition, it is more preferable that sodium p-toluenesulfonic acid is contained.

From the viewpoint of improving the preservation stability and suppressing aggravation of surface roughness after cleaning, the content of the solubilizer in the detergent composition according to the present disclosure is preferably 20.00 mass % or more, and more preferably 55.00 mass % or more, and, preferably 62.00 mass % or less, and more preferably 60.70 mass % or less relative to the total mass of the components other than water. Furthermore, it is preferably 20.00 mass % or more, and more preferably 50.00 mass % or more, and, preferably 62.00 mass % or less, more preferably 58.00 mass % or less, and further preferably 55.0 mass % or less relative to the total mass of the components other than water, from the viewpoint of improving the preservation stability and improving the cleaning performance.

[Anionic Polymer]

From the viewpoint of improving the cleaning performance, it is preferable that the detergent composition according to the present disclosure includes an anionic polymer. An example of the anionic polymer is a carboxylic acid-based polymer. Examples of the carboxylic acid-based polymer include an anionic polymer containing methacrylic acid or acrylic acid as the element, such as an acrylic acid polymer, a methacrylic acid polymer, a maleic acid polymer, a copolymer of acrylic acid/methacrylic acid, a copolymer of acrylic acid/maleic acid, a copolymer of methacrylic acid/acrylic acid methyl ester, etc. Among them, a copolymer of acrylic acid (AA) and 2-acrylamide-2-methylpropanesulfonic acid (AMPS) is preferred, and a copolymer where the molar ratio of AA to AMPS is 91/9-95/5 is more preferred. In an anionic polymer, the anionic part in the polymer may form partially or wholly a salt with an alkali metal. From the viewpoint of solubility in water, it is preferable that the anionic polymer is a sodium salt.

From the viewpoint of suppressing aggravation of the surface roughness after cleaning, the content of the anionic polymer in the detergent composition according to the present disclosure is preferably 2.50 mass % or more, more preferably 6.30 mass % or more, and further preferably 6.80 mass % or more, and, preferably 7.50 mass % or less, and more preferably 6.95 mass % or less relative to the total mass of the components other than water. Furthermore, it is preferably 2.50 mass % or more, and more preferably 6.00 mass % or more, and, preferably 7.50 mass % or less, more preferably 6.60 mass % or less, and further preferably 6.30 mass % or less relative to the total mass of the components other than water, from the viewpoint of improving the cleaning performance.

[Chelating Agent]

From the viewpoint of improving the cleaning performance, it is preferable that the detergent composition according to the present disclosure contains a chelating agent. An example of the chelating agent is at least one selected from the group consisting of: aldonic acids such as gluconic acid, glucoheptonic acid and the like; aminocarboxylic acids such as ethylenediaminetetraacetic acid and the like; hydroxycarboxylic acids such as citric acid, malic acid and the like; phosphoric acids such as 1-hydroxyethylidene-1,1-diphosphonic acid and the like; and alkali metal salts thereof. Among them, sodium gluconate, sodium glucoheptonate, sodium ethylenediaminetetraacetate, sodium citrate, or 1-hydroxyethylidene-1,1-diphosphonic acid is preferred, and 1-hydroxyethylidene-1,1-diphosphonic acid is more preferred. These chelating agents may be used singly or as a mixture of two or more.

From the viewpoint of suppressing aggravation of surface roughness after cleaning, the content of the chelating agent in the detergent composition according to the present disclosure is preferably 3.80 mass % or more, more preferably 9.50 mass % or more, and further preferably 10.20 mass % or more, and, preferably 10.60 mass % or less, and more preferably 10.45 mass % or less relative to the total mass of the components other than water. It is 3.80 mass % or more, and more preferably 9.20 mass % or more, and, preferably 10.60 mass % or less, more preferably 10.00 mass % or less, and further preferably 9.40 mass % or less relative to the total mass of the components other than water, from the viewpoint of improving the cleaning performance.

[Water]

The detergent composition according to the present disclosure contains water. The water is not particularly limited insofar as it can serve as a solvent, and the examples may be ultrapure water, pure water, ion exchange water, distilled water and the like. Ultrapure water, pure water or ion exchange water is preferred, and ultrapure water is more preferred. Pure water and ultrapure water can be obtained by, for example, passing tap water through activated carbon, followed by ion exchange treatment, distillation, and as necessary, irradiation using a specific ultraviolet germicidal lamp, or passing through a filter. Though the detergent composition may further include an aqueous organic solvent (for example, an alcohol such as ethanol) as a solvent in addition to water as described above, it is preferable that the solvent included in the detergent composition is composed solely of water.

From the viewpoint of suppressing aggravation of surface roughness, the content of the water in the detergent composition is preferably 98.50 mass % or less, and more preferably 99.70 mass % or less. From the similar viewpoint, preferably it is 98.80 mass % or more, and more preferably 99.00 mass % or more.

[Mass Ratio of Amine/Alkali Metal Ion]

In the present disclosure, it is possible to suppress aggravation of the surface roughness by use of an amine and an inorganic alkali. Other than the alkali metal derived from the inorganic alkali to be blended, alkali metal ions derived from counter ions of a chelating agent and salts of anionic polymers etc. are contained, and they are considered as serving similarly to an inorganic alkali. Therefore, with respect to suppression of surface roughness and improvement of cleaning performance, it is preferable to specify not the ratio of amine to inorganic alkali but the quantitative ratio of amine to alkali metal ion. From the viewpoint of suppressing aggravation of the surface roughness after cleaning, the mass ratio of amine to alkali metal ion (content of amine)/(content of alkali metal ion) is preferably 0.50 or more, more preferably 1.18 or more, and further preferably 1.80 or more, and, preferably 12.00 or less, more preferably 4.00 or less, and further preferably 2.00 or less from the viewpoint of suppressing aggravation of the surface roughness after cleaning. The mass ratio of the amine to the alkali metal ion is preferably 0.60 or more, and more preferably 0.80 or more, and, preferably 12.00 or less, and more preferably 1.15 or less from the viewpoint of improving the cleaning performance. The mass ratio of the amine/alkali metal ion can be obtained by measuring the total amount of the inorganic alkali in the detergent composition by an atomic absorption method and by calculating the result.

[Method for Preparing Detergent Composition]

The detergent composition according to the present disclosure can be prepared by mixing the respective components. In many cases, from the viewpoint of storage and transportation, the detergent composition is produced in the form of a concentrated liquid and diluted in use. The detergent composition may be used directly, or a concentrated liquid of the detergent composition may be prepared and diluted in use. When the concentrated liquid of the detergent composition is diluted, the dilution rate is not particularly limited, and can be determined appropriately in accordance with the concentrations of the respective components in the concentrated liquid, the cleaning conditions, or the like. From the viewpoint of suppressing aggravation of the surface roughness after cleaning, it is preferable that the concentrated liquid of the detergent composition is diluted to 10 mass % or less, and more preferably, diluted to 5 mass % or less. Further, from the viewpoint of cleaning performance, preferably the concentrated liquid of the detergent composition is diluted to 0.005 mass % or more, more preferably 0.3 mass % or more, and further preferably 1 mass % or more.

[Concentrate of Detergent Composition]

The concentrated liquid of the detergent composition according to the present disclosure can be prepared by mixing the respective components. The content of each of the components other than water is substantially equivalent to those of a detergent composition. From the viewpoint of storage and transportation, the content of water in the concentrated liquid of the detergent composition is preferably 95.00 mass % or less, and more preferably 90.00 mass % or less, and, from a similar viewpoint, it is preferably 60.00 mass % or more, and more preferably 70.00 mass % or more. Therefore, in one or a plurality of embodiments, the method for cleaning a glass substrate according to the present disclosure includes dilution of the concentrated liquid of the detergent composition.

From the viewpoint of improving the cleaning performance after dilution, a pH of the concentrated liquid of the detergent composition according to the present disclosure is preferably 8.80 or more, more preferably 9.00 or more, and further preferably 10.00 or more. It is preferably 12.50 or less, more preferably 12.00 or less, and further preferably 11.00 or less, from the viewpoint of suppressing aggravation of the surface roughness after cleaning. The pH of the concentrated liquid of the detergent composition can be measured by a method similar to the method for measuring a pH of a detergent composition.

[Method for Cleaning Glass Substrate]

The method for cleaning a glass substrate according to the present disclosure is a method for polishing a crystallized glass substrate to be polished that is made of a crystallized glass by use of the detergent composition according to the present disclosure, and in one or a plurality of embodiments, the method includes a step of bringing the detergent composition according to the present disclosure into contact with the crystallized glass substrate to be cleaned. Examples of one or a plurality of embodiments of this step include (a) a method of immersing the crystallized glass substrate to be cleaned that is made of a crystallized glass in the detergent composition, and/or, (b) a method of injecting the detergent composition whereby feeding the detergent composition onto the surface of the crystallized glass substrate to be cleaned that is made of a crystallized glass.

In the above-described method (a), although there is no particular limitation on the conditions for immersing the crystallized glass substrate to be cleaned in the detergent composition, for example, it is preferable that the temperature of the detergent composition is in a range of 20 to 100° C. from the viewpoint of handleability and operability; the time for immersion is preferably 5 seconds or more, more preferably 10 seconds or more, and further preferably 100 seconds or more from the viewpoint of improving the cleaning performance due to the detergent composition. Preferably, it is 30 minutes or less, more preferably 10 minutes or less, and further preferably 5 minutes or less from the viewpoint of improving the efficiency in production of a crystallized glass substrate that has been cleaned. Further, it is preferable that the detergent composition is applied with an ultrasonic vibration from the viewpoint of enhancing the performance in removing residue and dispersibility of the residue. The frequency of the ultrasonic is preferably in a range of 20 to 2000 kHz, more preferably 40 to 2000 kHz, and further preferably 40 to 1500 kHz.

In the above-described method (b), from the viewpoint of promoting the performance in cleaning residues such as polishing particles and solubility of oils, it is preferable that a detergent composition applied with ultrasonic vibration is injected to be brought into contact with the surface of the crystallized glass substrate to be cleaned, thereby cleaning the surface; or the detergent composition is fed by injection onto the surface of the crystallized glass substrate to be cleaned, and then the surface fed with the detergent composition is rubbed with a brush. Furthermore, it is preferable that the detergent composition applied with the ultrasonic vibration is fed by injection onto the surface of an object to be cleaned, and then the surface fed with the detergent composition is rubbed with a brush for cleaning.

For the means to feed the detergent composition onto the surface of the substrate to be cleaned, any means such as a spray nozzle or the like can be used. There is no particular limitation on the brush for cleaning, and for example, a nylon brush, a PVA (polyvinyl alcohol) sponge brush and the like can be used. The frequency of the ultrasonic is substantially equivalent to that preferably employed in the above-mentioned method (a).

Further in one or a plurality of embodiments, at least one cleaning step such as shake-cleaning, a cleaning utilizing rotation of a spinner or the like, a paddle cleaning and the like can be contained in addition to the above-mentioned method (a) and/or the above-mentioned method (b).

In the method for cleaning a glass substrate according to the present disclosure, the crystallized glass substrates to be cleaned may be cleaned one by one; a plurality of ready-to-clean crystallized glass substrates to be cleaned may be cleaned in a batch. The number of baths used for cleaning may be one or more than one.

[Method for Producing a Glass Hard Disk Substrate]

Generally, a glass hard disk substrate is produced through steps starting with a step of obtaining a crystallized glass base by mold-pressing of molten glass or cutting-off from sheet glass, followed by a profiling step, an edge polishing step, a rough grinding step, a fine grinding step, a rough polishing step, a final polishing step and a chemical strengthening step. The chemical strengthening step may be performed before the final polishing step. A cleaning step may be interposed between the respective steps. The glass hard disk substrate becomes a magnetic hard disk after experiencing a step of forming a recording portion after a final cleaning step. In the present invention, a glass hard disk substrate of a crystallized glass is subjected to these steps.

In one or a plurality of embodiments, the step of forming a recording portion is carried out by forming a magnetic layer on a glass hard disk substrate by a method such as sputtering. Here, the magnetic layer has a magnetic recording region and includes a metal thin film. Examples of the metal material for forming the metal thin film include cobalt alloy which is an alloy of cobalt and chromium, tantalum, platinum or the like, an alloy of iron and platinum, and the like. The magnetic layer may be formed on the both main surfaces of the glass hard disk substrate, or it may be formed on only either of the main surfaces.

The rough polishing step and the final polishing step are carried out in this order. Inorganic fine particles included in the polishing agent composition used at the time of the rough polishing step is preferably ceric oxide particles because the particles enable a high-speed polishing. The inorganic fine particles included in the polishing agent composition used at the time of the final polishing step are preferably silica particles because the particles improve the flatness (less rough) of the surface.

The rough polishing step can be followed by a cleaning step (first cleaning step) using a detergent composition, a rinsing step (first rinsing step), a drying step (first drying step), a final polishing step, a cleaning step (second cleaning step) using a detergent composition, a rinsing step (second rinsing step), and a drying step (second drying step) in this order. The method for cleaning a glass substrate according to the present disclosure can be applied to the first cleaning step and/or the second cleaning step. In one or a plurality of non-limited embodiments, it is preferable that the method for cleaning a glass substrate according to the present disclosure is applied to the second cleaning step from the viewpoint of the cleaning performance.

Therefore, in one aspect, the present disclosure relates to a method for producing a glass hard disk substrate including steps (1) and (2) below:

step (1) of polishing a crystallized glass substrate to be polished by use of a polishing liquid composition; and

step (2) of cleaning the substrate obtained in the step (1) by use of the detergent composition according to the present disclosure.

The substrate to be polished in the step (1) is a crystallized glass substrate that in general has experienced a fine grinding step, and preferably experienced a rough polishing step. The crystallized glass substrate is as stated above. The step (1) can be carried out by feeding a polishing liquid composition on the surface to be polished of the crystallized glass substrate, bringing a polishing pad into contact with the surface to be polished, and moving the polishing pad or the substrate to be polished while applying them with a predetermined pressure (load), for example. This step (1) is preferably a final polishing step to use a polishing liquid composition including silica particles, from the viewpoint of improving the quality of the final substrate. Further it is preferable that the polishing liquid composition is used repeatedly in the final polishing step.

The cleaning step of the step (2) can be carried out similarly to the above-mentioned step of cleaning a glass substrate according to the present disclosure.

[Method for Cleaning Glass Hard Disk Substrate Surface]

In another aspect, the present disclosure relates to a method for cleaning a glass hard disk substrate surface. In one or a plurality of embodiments, it includes a cleaning step of cleaning a crystallized glass substrate to be cleaned by use of a cleaning agent composition of the present invention. Here, the glass substrate has glass surfaces polished by use of the polishing liquid composition. One or a plurality of embodiments for this step include: (a) a method of immersing a crystallized glass substrate to be cleaned in a detergent composition, and/or, (b) a method of injecting a detergent composition so as to feed the detergent composition onto the surface of a crystallized glass substrate to be cleaned. The methods (a) and (b) are as mentioned above.

Hereinafter, one or a plurality of non-limited embodiments of steps in a method for cleaning a glass hard disk substrate surface will be illustrated.

(1) Cleaning-1: A cleaning tank (a) of the detergent composition of the present invention is set to a predetermined temperature, in which an uncleaned substrate is immersed so as to be cleaned while being irradiated with ultrasonic;
(2) Rinsing-1: A rinsing tank (b) of ultrapure water is set to a predetermined temperature, the uncleaned substrate is transferred from the cleaning tank (a) to the rinsing tank (b) and immersed therein so as to be rinsed while being irradiated with ultrasonic;
(3) The steps (1) and (2) are repeated using a cleaning tank (c) of the detergent composition according to the present disclosure and a rinsing tank (d) of ultrapure water;
(4) Cleaning-2: The substrate to be cleaned is transferred from the rinsing tank to a scrub-cleaning unit (A) equipped with cleaning brushes, the detergent composition of the present invention is injected toward the cleaning brushes, and the cleaning brushes are pressed onto the both surfaces of the substrate while rotating the brushes under presence of the detergent composition for the purpose of cleaning;
(5) Rinsing-2: The substrate to be cleaned is transferred to a scrub-cleaning unit (B), onto which ultrapure water is injected and a cleaning brushes are pressed onto the both surfaces of the substrate while rotating the substrate similarly to (4), thereby rinsing the substrate.
(6) The steps (4) and (5) are repeated by using a scrub-cleaning unit (C) prepared under the conditions similar to those of the scrub-cleaning unit (A), and a scrub-cleaning unit (D) prepared under the conditions similar to those of the scrub-cleaning unit (B).
(7) Rinsing-3: the substrate to be cleaned is transferred to a rinsing tank (e) of ultrapure water and rinsed.
(8) Drying: The substrate to be cleaned is transferred to a rinsing tank (f) of warm pure water, immersed therein, and the substrate to be cleaned is pulled out at a predetermined rate, and then the surfaces of the substrate are dried completely.

In the method for cleaning a glass substrate to be cleaned according to the present disclosure, the glass substrates to be cleaned may be cleaned one by one; a plurality of ready-to-clean crystallized glass substrates to be cleaned may be cleaned in a batch. The number of baths used for cleaning may be one or more than one.

The present invention further relates to the following one or a plurality of embodiments.

<1> A method for cleaning a glass substrate, comprising bringing a detergent composition into contact with a glass substrate to be cleaned,

wherein the detergent composition contains an amine including 1 to 10 nitrogen atoms and an inorganic alkali,

a content of the amine is in a range of 5.00 mass % to 70.00 mass % relative to the total mass of components of the detergent composition other than water,

the glass substrate to be cleaned is a crystallized glass substrate, and

a pH of the detergent during cleaning is in a range of 9.0 to 11.50.

<2> The method for cleaning a glass substrate according to <1>, wherein preferably the crystallized glass substrate to be cleaned is a substrate that has been polished with silica particles.

<3> The method for cleaning a glass substrate according to <1> or <2>, wherein the surface roughness Ra before cleaning of the crystallized glass substrate to be cleaned is preferably 1.70 Å or more, and/or, preferably 2.50 Å or less, and more preferably 2.20 Å or less.

<4> The method for cleaning a glass substrate according to any one of <1> to <3>, wherein the pH of the detergent composition is in a range of 9.00 to 11.50, or, 11.50 or less, preferably 11.00 or less, and more preferably 10.70 or less, and/or, 9.00 or more, more preferably 9.50 or more, further preferably 10.00 or more, even further preferably 10.50 or more, even further preferably 10.90 or more, and even further preferably 11.0 or more.

<5> The method for cleaning a glass substrate according to any one of <1> to <4>, wherein the amine preferably does not contain aminocarboxylic acids such as ethylenediaminetetraacetic acid.

<6> The method for cleaning a glass substrate according to any one of <1> to <5>, wherein the number of the nitrogen atoms included in the amine is 10 or less, preferably 8 or less, more preferably 6 or less, further preferably 3 or less, and even further preferably 2 or less, and/or, 1 or more, preferably 2 or more, and more preferably 5 or more, and, preferably 6 or less, and/or, in a range of 2 to 8, or 2 to 3.

<7> The method for cleaning a glass substrate according to any one of <1> to <6>, wherein the molecular weight or the weight average molecular weight of the amine is preferably 500 or less, more preferably 400 or less, further preferably 300 or less, and even further preferably 150 or less, and/or, preferably 50 or more, and more preferably 100 or more, and/or, preferably 40 or more, more preferably 50 or more, further preferably 80 or more, even further preferably 150 or more, and even further preferably 200 or more, and/or, preferably 300 or less, and more preferably 250 or less.

<8> The method for cleaning a glass substrate according to any one of <1> to <7>, wherein the amine is at least one selected from the group consisting of a compound represented by General Formula (I), alkanolamine, and a compound having a piperazine ring:

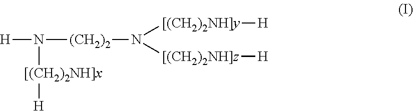

[in Formula (I), x, y and z respectively denote integers in a range of 0 to 4, satisfying 1≦x+y+z≦4].

<9> The method for cleaning a glass substrate according to any one of <1> to <8>, wherein preferably the amine is at least one selected from the group consisting of tetraethylenepentamine, pentaethylenehexamine, monoethanolamine, 2-[(2-aminoethyl)amino]ethanol, and 1-(2-hydroxyethyl)piperazine.

<10> The method for cleaning a glass substrate according to any one of <1> to <9>, wherein the content of the amine is in a range of 5.00 mass % to 70.00 mass %, and/or, preferably 8.00 mass % or more, more preferably 15.70 mass % or more, and further preferably 16.5 mass % or more, and/or, 50.00 mass % or less, more preferably 45.00 mass % or less, and further preferably 20.00 mass % or less, and/or, preferably 8.00 mass % or more, and more preferably 15.00 mass % or more, and/or, preferably 15.70 mass % or less relative to the total mass of the components other than water.

<11> The method for cleaning a glass substrate according to any one of <1> to <10>, wherein a content of the inorganic alkali in terms of an alkali metal ion amount is preferably 1.00 mass % or more, and/or, preferably 2.00 mass % or less, and more preferably 1.70 mass % or less, and/or, preferably 1.00 mass % or more, more preferably 1.50 mass % or more, and further preferably 1.80 mass % or more.

<12> The method for cleaning a glass substrate according to any one of <1> to <11>, wherein preferably the detergent composition further contains a nonionic surfactant, and more preferably the nonionic surfactant is a nonionic surfactant represented by General Formula (II) below:

R—O-(EO)o(PO)p-H (II)

[in Formula (II), R is a linear or branched alkyl group having 6-16 carbon atoms, o is an average number of added moles of EO, and p is an average number of added moles of PO; o is a number in a range of 0 to 20, and p is a number in a range of 0 to 5].

<13> The method for cleaning a glass substrate according to <12>, wherein a content of the nonionic surfactant is preferably 1.00 mass % or more, more preferably 3.95 mass % or more, and further preferably 4.20 mass % or more, and/or, preferably 5.00 mass % or less, and more preferably 4.35 mass % or less, and/or, preferably 1.00 mass % or more, more preferably 1.50 mass % or more, and further preferably 3.00 mass % or more, and/or, preferably 5.00 mass % or less, and more preferably 3.95 mass % or less relative to the total mass of the components other than water.

<14> The method for cleaning a glass substrate according to any one of <1> to <13>, wherein preferably the detergent composition further contains at least one solubilizer selected from the group consisting of organic sulfonic acids such as p-toluenesulfonic acid, dimethylbenzenesulfonic acid, and the like; 2-ethylhexanoic acid; and salts thereof.

<15> The method for cleaning a glass substrate according to <14>, wherein a content of the solubilizer is preferably 20.00 mass % or more, and more preferably 55.00 mass % or more, and/or, preferably 62.00 mass % or less, and more preferably 60.70 mass % or less, and/or, preferably 20.00 mass % or more, and more preferably 50.00 mass % or more, and/or preferably 62.00 mass % or less, more preferably 58.00 mass % or less, and further preferably 55.00 mass % or less relative to the total mass of the components other than water.

<16> The method for cleaning a glass substrate according to any one of <1> to <15>, wherein the detergent composition further contains an anionic polymer, preferably a carboxylic acid-based polymer, more preferably, a (co)polymer selected from the group consisting of an acrylic acid polymer, a methacrylic acid polymer, a maleic acid polymer, a copolymer of acrylic acid/methacrylic acid, a copolymer of acrylic acid/maleic acid, and a copolymer of methacrylic acid/acrylic acid methyl ester.

<17> The method for cleaning a glass substrate according to <16>, wherein a content of the anionic polymer is preferably 2.50 mass % or more, more preferably 6.30 mass % or more, and further preferably 6.80 mass % or more, and/or, preferably 7.50 mass % or less, and more preferably 6.95 mass % or less, and/or, preferably 2.50 mass % or more, and more preferably 6.00 mass % or more, and/or, preferably 7.50 mass % or less, more preferably 6.6 mass % or less, and further preferably 6.30 mass % or less relative to the total mass of the components other than water.

<18> The method for cleaning a glass substrate according to any one of <1> to <17>, wherein the detergent composition contains further a chelating agent, preferably, at least one selected from the group consisting of aldonic acids such as gluconic acid, glucoheptonic acid and the like; aminocarboxylic acids such as ethylenediaminetetraacetic acid and the like; hydroxycarboxylic acids such as citric acid, mark acid and the like; phosphonic acids such as 1-hydroxyethylidene-1,1-diphosphonic acid and the like; and alkali metal salts thereof.

<19> The method for cleaning a glass substrate according to <18>, wherein a content of the chelating agent is preferably 3.80 mass % or more, more preferably 9.50 mass % or more, and further preferably 10.20 mass % or more, and/or, preferably 10.60 mass % or less, and more preferably 10.45 mass % or less, and/or, preferably 3.80 mass % or more, and more preferably 9.20 mass % or more, and/or, preferably 10.60 mass % or less, more preferably 10.00 mass % or less, and further preferably 9.40 mass % or less relative to the total mass of the components other than water.

<20> The method for cleaning a glass substrate according to any one of <1> to <19>, wherein a content of the water in the detergent composition is preferably 98.50 mass % or less, and more preferably 99.70 mass % or less, and/or, preferably 98.80 mass % or more, and more preferably 99.00 mass % or more.

<21> The method for cleaning a glass substrate according to any one of <1> to <20>, wherein the mass ratio of the amine to an alkali metal ion in the detergent composition (content of amine)/(content of alkali metal ion) is preferably in a range of 0.50 to 12.00, and/or, preferably 0.50 or more, more preferably 1.18 or more, and further preferably 1.80 or more, and/or, preferably 12.00 or less, more preferably 4.00 or less, and further preferably 2.00 or less, and/or, preferably 0.60 or more, and more preferably 0.80 or more, and/or, preferably 12.00 or less, and more preferably 1.15 or less.

<22> The method for cleaning a glass substrate according to any one of <1> to <21>, comprising diluting a concentrated liquid of the detergent composition, wherein the content of water in the concentrated liquid is preferably 95.00 mass % or less, and more preferably 90.00 mass % or less, and/or, preferably 60.00 mass % or more, and more preferably 70.00 mass % or more.

<23> The method for cleaning a glass substrate according to any one of <1> to <22>, wherein the glass substrate to be cleaned is preferably a glass substrate for a glass hard disk substrate.

<24> A method for producing a glass hard disk substrate, comprising steps (1) and (2) below:

step (1) of polishing a glass substrate to be polished by use of a polishing liquid composition; and

step (2) of cleaning the substrate obtained in step (1) by use of a detergent composition,

wherein the detergent composition contains an amine including 1 to 10 nitrogen atoms and an inorganic alkali,

a content of the amine is in a range of 5.00 mass % to 70.00 mass % relative to the total mass of components of the detergent composition other than water,

the glass substrate to be cleaned is a crystallized glass substrate, and

a pH of the detergent during cleaning is in a range of 9.0 to 11.50.

<25> The method for producing a glass hard disk substrate according to <24>, wherein the cleaning of the step (2) is carried out by the method for cleaning a glass substrate according to any one of <1> to <23>.

The present invention relates further to the following one or a plurality of embodiments.

<A1> A method for producing a glass hard disk substrate, comprising steps (1) and (2) below:

step (1) of polishing a glass substrate to be polished by use of a polishing liquid composition; and

step (2) of cleaning the substrate obtained in step (1) by use of a detergent composition,

wherein the detergent composition contains an amine including 1 to 10 nitrogen atoms and an inorganic alkali,

a content of the amine is in a range of 5.00 mass % to 70.00 mass % relative to the total mass of components of the detergent composition other than water,

the glass substrate to be cleaned is a crystallized glass substrate, and

a pH of the detergent composition during cleaning is in a range of 9.0 to 11.5.

<A2> The method for producing a glass substrate according to <A1>, wherein the polishing liquid composition is a polishing liquid composition including silica particles.

<A3> The method for producing a glass hard disk substrate according to <A1> or <A2>, wherein the detergent composition contains an alkali metal derived from an inorganic alkali, and the mass ratio of the amine to an alkali metal ion in the detergent composition (content of amine)/(content of alkali metal ion) is in a range of 0.50 to 12.00.

<A4> The method for producing a glass hard disk substrate according to any one of <A1> to <A3>, wherein the amine is at least one selected from the group consisting of a compound represented by General Formula (I), alkanolamine, and a compound having a piperazine ring:

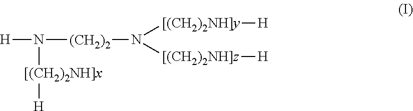

[in Formula (I), x, y and z respectively denote integers in a range of 0 to 4, satisfying 1≦x+y+z≦4].

<A5> The method for producing a glass hard disk substrate according to any one of <A1> to <A4>, wherein the amine is at least one selected from the group consisting of tetraethylenepentamine, pentaethylenehexamine, monoethanolamine, 2-[(2-aminoethyl)amino]ethanol, and 1-(2-hydroxyethyl)piperazine.

<A6> The method for producing a glass hard disk substrate according to any one of <A1> to <A5>, wherein the detergent composition further contains a nonionic surfactant represented by General Formula (II) below:

R—O-(EO)o(PO)p-H (II)

[in Formula (II), R is a linear or branched alkyl group having 6-16 carbon atoms, o is an average number of added moles of EO, and p is an average number of added moles of PO; o is a number in a range of 0 to 20, and p is a number in a range of 0 to 5].

<A7> The method for producing a glass hard disk substrate according to <A6>, wherein a content of the nonionic surfactant is in a range of 1.0 mass % to 5.0 mass % relative to the total mass of the components other than water.

<A8> The method for producing a glass hard disk substrate according to any one of <A1> to <A7>, wherein the detergent composition further contains at least one solubilizer selected from the group consisting of organic sulfonic acids such as p-toluenesulfonic acid, dimethylbenzenesulfonic acid, and the like; 2-ethylhexanoic acid; and salts thereof.

<A9> The method for producing a glass hard disk substrate according to <A8>, wherein a content of the solubilizer is in a range of 20.0 mass % to 62.0 mass % relative to the total mass of the components other than water.

<A10> The method for producing a glass hard disk substrate according to any one of <A1> to <A9>, wherein the detergent composition contains further an anionic polymer.

<A11> The method for producing a glass hard disk substrate according to <A10>, wherein a content of the anionic polymer is in a range of 2.5 mass % to 7.5 mass % relative to the total mass of the components other than water.

<A12> The method for producing a glass hard disk substrate according to any one of <A1> to <A11>, wherein the detergent composition contains further a chelating agent.

<A13> The method for producing a glass hard disk substrate according to <A12>, wherein a content of the chelating agent is in a range of 3.8 mass % to 10.6 mass % relative to the total mass of the components other than water.

<A14> The method for producing a glass hard disk substrate according to any one of <A1> to <A13>, comprising diluting a concentrated liquid of the detergent composition containing water in a range of 60.0 mass % to 95.0 mass %.

<A15> A method for producing a glass hard disk substrate, comprising steps (1) and (2) below:

step (1) of polishing a glass substrate to be polished by use of a polishing liquid composition; and

step (2) of cleaning the substrate obtained in step (1) by use of a detergent composition,

wherein the detergent composition contains an amine including 1 to 10 nitrogen atoms and an inorganic alkali,

a content of the amine is in a range of 5.0 mass % to 70.0 mass % relative to the total mass of components of the detergent composition other than water,

the glass substrate to be cleaned is a crystallized glass substrate, and

a pH of the detergent during cleaning is in a range of 9.0 to 11.5.

<A16> A method for cleaning a glass substrate, comprising bringing the detergent composition into contact with a glass substrate to be cleaned,

wherein the detergent composition contains an amine including 1 to 10 nitrogen atoms and an inorganic alkali,

a content of the amine is in a range of 5.0 mass % to 70.0 mass % relative to the total mass of components of the detergent composition other than water,

the glass substrate to be cleaned is a crystallized glass substrate, and

a pH of the detergent during cleaning is in a range of 9.0 to 11.5.

<A17> The method for cleaning a glass substrate according to <A16>, wherein the crystallized glass substrate to be cleaned is a substrate that has been polished with silica particles.

<A18> The method for cleaning a glass substrate according to <A16> or <A17>, wherein the mass ratio of the amine to an alkali metal ion in the detergent composition (content of amine)/(content of alkali metal ion) is in a range of 0.5 to 12.0.

<A19> The method for cleaning a glass substrate according any one of <A16> to <A18>, wherein the amine is at least one selected from the group consisting of a compound represented by General Formula (I), alkanolamine, and a compound having a piperazine ring:

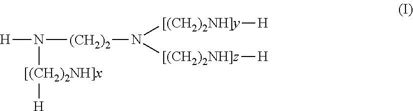

[in Formula (I), x, y and z respectively denote integers in a range of 0 to 4, satisfying 1≦x+y+z≦4].

<A20> The method for cleaning a glass substrate according any one of <A16> to <A19>, comprising diluting a concentrated liquid of the detergent composition containing water in a range of 60.0 mass % to 95.0 mass %.

<A21> The method for cleaning a glass substrate according any one of <A16> to <A20>, wherein the glass substrate to be cleaned is a glass substrate for a glass hard disk substrate.

The present invention further relates to the following one or a plurality of embodiments.

<B1> A use of a detergent composition in a method for cleaning a glass substrate, comprising bringing a glass substrate to be cleaned into contact with the detergent composition,

wherein the detergent composition contains an amine including 1 to 10 nitrogen atoms and an inorganic alkali,

a content of the amine is in a range of 5.0 mass % to 70.0 mass % relative to the total mass of components of the detergent composition other than water,

the glass substrate to be cleaned is a crystallized glass substrate, and

a pH of the detergent during cleaning is in a range of 9.0 to 11.5.

<B2> The use of a detergent composition according to <B1>, wherein the crystallized glass substrate to be cleaned is a substrate that has been polished with silica particles.

<B3> The use of a detergent composition according to <B1> or <B2>, wherein the detergent composition contains an alkali metal derived from an inorganic alkali, and the mass ratio of the amine to an alkali metal ion in the detergent composition (content of amine)/(content of alkali metal ion) is in a range of 0.5 to 12.0.

<B4> The use of a detergent composition according to <B1> or <B2>, wherein the amine is at least one selected from the group consisting of a compound represented by General Formula (I), alkanolamine, and a compound having a piperazine ring:

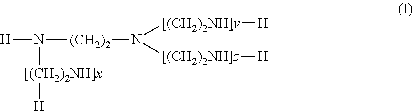

[in Formula (I), x, y and z respectively denote integers in a range of 0 to 4, satisfying 1≦x+y+z≦4].

<B5> The use of a detergent composition according to any one of <B1> to <B4>, comprising diluting a concentrated liquid of the detergent composition containing water in a range of 60 mass % to 95 mass %.

<B6> The use of a detergent composition according to any one of <B1> to <B5>, wherein the detergent composition further contains a nonionic surfactant represented by General Formula (II) below:

R—O-(EO)o(PO)p-H (II)

[in Formula (II), R is a linear or branched alkyl group having 6-16 carbon atoms, o is an average number of added moles of EO, and p is an average number of added moles of PO; o is a number in a range of 0 to 20, and p is a number in a range of 0 to 5].

<B7> The use of a detergent composition according to <B6>, wherein a content of the nonionic surfactant is in a range of 1.0 mass % and 5.0 mass % relative to the total mass of the components other than water.

<B8> The use of a detergent composition according to any one of <B1> to <B7>, wherein the detergent composition further contains at least one solubilizer selected from the group consisting of organic sulfonic acids such as p-toluenesulfonic acid, dimethylbenzenesulfonic acid, and the like; 2-ethylhexanoic acid; and salts thereof.

<B9> The use of a detergent composition according to <B8>, wherein a content of the solubilizer is in a range of 20.0 mass % to 62.0 mass % relative to the total mass of the components other than water.

<B10> The use of a detergent composition according to any one of <B1> to <B9>, wherein the detergent composition contains further an anionic polymer.

<B11> The use of a detergent composition according to <B10>, wherein a content of the anionic polymer is in a range of 2.5 mass % to 7.5 mass % relative to the total mass of the components other than water.

<B12> The use of a detergent composition according to any one of <B1> to <B11>, wherein the detergent composition contains further a chelating agent.

<B13> The use of a detergent composition according to <B12>, wherein a content of the chelating agent is in a range of 3.8 mass % to 10.6 mass % relative to the total mass of the components other than water.

<B14> The use of a detergent composition according to any one of <B1> to <B13>, comprising steps (1) and (2) below:

step (1) of polishing a glass substrate to be polished by use of the polishing liquid composition; and

step (2) of cleaning the substrate obtained in step (1) by use of the detergent composition.

The present invention further relates to the following one or a plurality of embodiments.

<C1> A method for cleaning a glass hard disk substrate, comprising bringing a detergent composition into contact with a glass substrate to be cleaned,

wherein the detergent composition contains an amine including 1 to 10 nitrogen atoms and an inorganic alkali,

a content of the amine is in a range of 5.0 mass % to 70.0 mass % relative to the total mass of components of the detergent composition other than water,

the glass substrate to be cleaned is a crystallized glass substrate, and

a pH of the detergent during cleaning is in a range of 9.0 to 11.5.

<C2> The method for cleaning a glass substrate according to <C1>, wherein preferably the crystallized glass substrate to be cleaned is a substrate that has been polished with silica particles.

<C3> The method for cleaning a glass substrate according to <C1> or <C2>, wherein a surface roughness Ra before cleaning of the crystallized glass substrate to be cleaned is preferably 1.7 Å or more, and/or, preferably 2.5 Å or less, and more preferably 2.2 Å or less.

<C4> The method for cleaning a glass substrate according to any one of <C1> to <C3>, wherein the pH of the detergent composition during cleaning is in a range of 9.0 to 11.5, or, 11.5 or less, preferably 11.0 or less, and more preferably 10.7 or less, and/or, 9.0 or more, preferably 9.5 or more, more preferably 10.0 or more, further preferably 10.5 or more, even further preferably 10.9 or more, and even further preferably 11.0 or more.

<C5> The method for cleaning a glass substrate according to any one of <C1> to <C4>, wherein preferably the amine does not contain aminocarboxylic acids such as ethylene diaminetetraacetic acid or the like.

<C6> The method for cleaning a glass substrate according to any one of <C1> to <C5>, wherein the number of the nitrogen atoms included in the amine is 10 or less, preferably 8 or less, more preferably 6 or less, further preferably 3 or less, and even further preferably 2 or less, and/or, 1 or more, preferably 2 or more, and more preferably 5 or more, and, preferably 6 or less, and/or, in a range of 2 to 8 or less, or 2 to 3.

<C7> The method for cleaning a glass substrate according to any one of <C1> to <C6>, wherein the molecular weight or the weight average molecular weight of the amine is preferably 500 or less, more preferably 400 or less, further preferably 300 or less, and even further preferably 150 or less, and/or, preferably 50 or more, and more preferably 100 or more, and/or, preferably 40 or more, more preferably 50 or more, further preferably 80 or more, even further preferably 150 or more, and even further preferably 200 or more, and/or, preferably 300 or less, and more preferably 250 or less.

<C8> The method for cleaning a glass substrate according to any one of <C1> to <C7>, wherein the amine is at least one selected from the group consisting of a compound represented by General Formula (I), alkanolamine, and a compound having a piperazine ring:

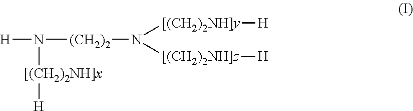

[in Formula x, y and z respectively denote integers in a range of 0 to 4, satisfying 1≦x+y+z≦4].

<C9> The method for cleaning a glass substrate according to any one of <C1> to <C8>, wherein preferably the amine is at least one selected from the group consisting of tetraethylenepentamine, pentaethylenehexamine, monoethanolamine, 2[(2-aminoethyl)amino]ethanol, and 1-(2-hydroxyethyl)piperazine.

<C10> The method for cleaning a glass substrate according to any one of <C1> to <C9>, wherein the content of the amine is in a range of 5.0 mass % to 70.0 mass %, and/or, preferably 8.0 mass % or more, more preferably 15.7 mass % or more, and further preferably 16.5 mass % or more, and/or, 50.0 mass % or less, more preferably 45.0 mass % or less, and further preferably 20.0 mass % or less, and/or, preferably 8.0 mass % or more, and more preferably 15.0 mass % or more, and/or preferably 15.7 mass % or less relative to the total mass of the components other than water.

<C11> The method for cleaning a glass substrate according to any one of <C1> to <C10>, wherein a content of the inorganic alkali in terms of the amount of alkali metal ion is preferably 1.0 mass % or more, and/or, preferably 2.0 mass % or less, more preferably 1.7 mass % or less, and/or, preferably 1.0 mass % or more, more preferably 1.5 mass % or more, and further preferably 1.8 mass % or more.

<C12> The method for cleaning a glass substrate according to any one of <C1> to <C11>, wherein preferably the detergent composition further contains a nonionic surfactant, and more preferably the nonionic surfactant is a nonionic surfactant represented by General Formula (II) below:

R—O-(EO)o(PO)p-H (II)

[in Formula (II), R is a linear or branched alkyl group having 6-16 carbon atoms, o is an average number of added moles of EO, and p is an average number of added moles of PO; o is a number in a range of 0 to 20, and p is a number in a range of 0 to 5].

<C13> The method for cleaning a glass substrate according to <C12>, wherein a content of the nonionic surfactant is preferably 1.0 mass % or more, more preferably 3.95 mass % or more, and further preferably 4.2 mass % or more, and/or, preferably 5.0 mass % or less, and more preferably 4.35 mass % or less, and/or, preferably 1.0 mass % or more, more preferably 1.5 mass % or more, and further preferably 3.0 mass % or more, and/or, preferably 5.0 mass % or less, and more preferably 3.95 mass % or less relative to the total mass of the components other than water.

<C14> The method for cleaning a glass substrate according to any one of <C1> to <C13>, wherein preferably the detergent composition further contains at least one solubilizer selected from the group consisting of organic sulfonic acids such as p-toluenesulfonic acid, dimethylbenzenesulfonic acid, and the like; 2-ethylhexanoic acid; and salts thereof.

<C15> The method for cleaning a glass substrate according to <C14>, wherein a content of the solubilizer is preferably 20.0 mass % or more, and more preferably 55.0 mass % or more, and/or; preferably 62.0 mass % or less, and more preferably 60.7 mass % or less, and/or, preferably 20.0 mass % or more, and more preferably 50.0 mass % or more, and/or, preferably 62.0 mass % or less, more preferably 58.0 mass % or less, and further preferably 55.0 mass % or less relative to the total mass of the components other than water.

<C16> The method for cleaning a glass substrate according to any one of <C1> to <C15>, wherein the detergent composition contains an anionic polymer; preferably a carboxylic acid-based polymer, more preferably, a (co)polymer selected from the group consisting of an acrylic acid polymer, a methacrylic acid polymer, a maleic acid polymer, a copolymer of acrylic acid/methacrylic acid, a copolymer of acrylic acid/maleic acid, and a copolymer of methacrylic acid/acrylic acid methyl ester.

<C17> The method for cleaning a glass substrate according to <C16>, wherein a content of the anionic polymer is preferably 2.5 mass % or more, more preferably 6.3 mass % or more, and further preferably 6.8 mass % or more, and/or, preferably 7.5 mass % or less, and more preferably 6.95 mass % or less, and/or, preferably 2.5 mass % or more, and more preferably 6.0 mass % or more, and/or, preferably 7.5 mass % or less, more preferably 6.6 mass % or less, and further preferably 6.3 mass % or less relative to the total mass of the components other than water.

<C18> The method for cleaning a glass substrate according to any one of <C1> to <C17>, wherein the detergent composition contains further a chelating agent, preferably contains at least one selected from the group consisting off aldonic acids such as gluconic acid, glucoheptonic acid and the like; aminocarboxylic acids such as ethylene diaminetetraacetic acid and the like; hydroxycarboxylic acids such as citric acid, malic acid and the like; phosphonic acids such as 1-hydroxyethylidene-1,1-diphosphonic acid and the like; and alkali metal salts thereof.

<C19> The method for cleaning a glass substrate according to <C18>, wherein a content of the chelating agent is preferably 3.8 mass % or more, more preferably 9.5 mass % or more, and further preferably 10.2 mass % or more, and/or, preferably 10.6 mass % or less, and more preferably 10.45 mass % or less, and/or, preferably 3.8 mass % or more, and more preferably 9.2 mass % or more, and/or preferably 10.6 mass % or less, more preferably 10.0 mass % or less, and further preferably 9.4 mass % or less relative to the total mass of the components other than water.

<C20> The method for cleaning a glass substrate according to any one of <C1> to <C19>, wherein a content of the water in the detergent composition is preferably 98.5 mass % or less, and more preferably 99.7 mass % or less, and/or, preferably 98.8 mass % or more, and more preferably 99.0 mass % or more.

<C21> The method for cleaning a glass substrate according to any one of <C1> to <C20>, wherein the mass ratio of the amine to an alkali metal ion in the detergent composition (content of amine)/(content of alkali metal ion) is preferably in a range of 0.5 to 12.0, and/or, preferably 0.5 or more, more preferably 1.18 or more, and further preferably 1.8 or more, and/or, preferably 12.0 or less, more preferably 4.0 or less, and further preferably 2.0 or less, and/or, preferably 0.6 or more, and more preferably 0.8 or more, and/or, preferably 12.0 or less, and more preferably 1.15 or less.

<C22> The method for cleaning a glass substrate according to any one of <C1> to <C21>, comprising diluting a concentrated liquid of the detergent composition, wherein the content of water in the concentrated liquid is preferably 95.0 mass % or less, and more preferably 90.0 mass % or less, and/or preferably 60.0 mass % or more, and more preferably 70.0 mass % or more.

<C23> The method for cleaning a glass substrate according to any one of <C1> to <C22>, wherein the glass substrate to be cleaned is a glass substrate for a glass hard disk substrate.

<C24> A method for producing a glass hard disk substrate, comprising steps (1) and (2) below:

step (1) of polishing a glass substrate to be polished by use of a polishing liquid composition; and

step (2) of cleaning the substrate obtained in step (1) by use of a detergent composition,

wherein the detergent composition contains an amine including 1 to 10 nitrogen atoms and an inorganic alkali,

the content of the amine is in a range of 5.0 mass % to 70.0 mass % relative to the total mass of components of the detergent composition other than water,

the glass substrate to be cleaned is a crystallized glass substrate, and

the pH of the detergent during cleaning is in a range of 9.0 to 11.5.

<C25> The method for producing a glass hard disk substrate according to <C24>, wherein the cleaning of the step (2) is carried out by the method for cleaning a glass substrate according to any one of <C1> to <C23>.

### Examples

### Preparation of Concentrated Liquid of Detergent Composition

The respective components were blended at mass % to obtain make-ups as described in Table 1 below and mixed to obtain concentrated liquids of detergent compositions of Examples 1-12, Comparative Examples 1-7 and Reference Examples 1-2. In Table 1, a content in the upper column indicates mass % relative to a total mass containing water and a content in the lower column indicates mass % relative to the total mass of components other than water. A pH indicates the pH of the detergent composition at 25° C., which can be measured by using a pH meter (HM-30G manufactured by DKK-TOA CORPORATION) and indicates a numerical value taken 3 minutes after immersing an electrode in the cleaning composition. In Table 1, pH in the upper column indicates a pH of a concentrated liquid of the prepared detergent composition and pH in the lower column indicates a pH at the time of cleaning (detergent composition as 3% diluent of the concentrated liquid described in the upper column).

The alkali metal ion amount in the detergent composition is obtained as the total amount of the sodium ion and the potassium ion measured by an atomic absorption method.

The conditions for measurement are as indicated below.

### [Pretreatment of Specimen and Measurement]

0.1 g of specimen was weighed precisely in a quartz crucible, subjected to a dry incineration, dissolved in hydrochloric acid and diluted in a measuring cylinder to 50 ml total, which was then diluted 25 times to make a specimen for measurement to be measured by an atomic absorption spectrometer (VARIAN SpectrAA 220 Atomic Absorption Spectrometer).

The components below were used for the detergent composition.

### [Amine]

2-[(2-aminoethyl)amino]ethanol (manufactured by Nippon Nyukazai Co., Ltd.)
Diethylenetriamine (manufactured by TOSOH CORPORATION, x+y+z=1 in General Formula (I))
Tetraethylenepentamine (manufactured by TOSOH CORPORATION, x+y+z=3 in General Formula (I))
Pentaethylenehexamine (manufactured by TOSOH CORPORATION, x+y+z=4 in General Formula (I))
1-(2-hydroxyethyl)piperazine (manufactured by Nippon Nyukazai Co., Ltd.)
Methyldiethanolamine (manufactured by Nippon Nyukazai Co., Ltd.)
Polyamine (manufactured by Nippon Nyukazai Co., Ltd., trade name: SP-006, molecular weight: 600)
Potassium hydroxide (manufactured by KANTO CHEMICAL CO., INC., Cica Special Grade defined by KANTO CHEMICAL CO., INC., solid: 48 wt %)

### [Nonionic Surfactant]

Mixture of a compound where R is a linear alkyl group having 12 carbon atoms, o=10 and p=1.5, and a compound where R is a linear alkyl group having 14 carbon atoms, o=10 and p=1.5, in General Formula (II).

### [Anionic Polymer]

Aqueous solution (solid: 40 wt %) of sodium salt of a copolymer compound (weight average molecular weight: 12,000) of acrylic acid/2-acrylamide-2-methylpropanesulfonic acid (92/8 (molar ratio))

### [Chelating Agent]

1-hydroxyethylidene-1,1-diphosphonic acid (manufactured by Solutia Inc., solid: 60 wt %)

### [Solubilizer]

Aqueous solution of sodium p-toluenesulfonic acid (manufactured by Meiyusangyo Co., Ltd., solid: 90 wt %)

[Method for Testing Performance of Cleaning Glass Substrate for Hard Disk]

A substrate was subjected to polishing with a polishing liquid slurry (polishing agent composition) of the compositions below thereby preparing a substrate to be cleaned which was soiled with abrasive grains derived from the polishing liquid slurry, polishing scraps derived from a substrate material and the like. The cleaning performance of the detergent composition was evaluated by using the substrate to be cleaned.

(Substrate for Evaluation)

As substrates for evaluation in Examples 1-12 and Comparative Examples 1-7, crystallized glass substrates (outer diameter: 65 mmφ, inner diameter: 20 mmφ, thickness: 0.635 mm) were prepared. As substrates for evaluation in Reference Examples 1-2, amorphous glass substrates (outer diameter: 65 mmφ, inner diameter: 20 mmφ, thickness: 0.635 mm) were prepared.

(Polishing Condition)

Polishing machine: Double-side 9B polisher (manufactured by Hamai Co., Ltd.)
Polishing pad: Suede pad for final polishing manufactured by FILWEL Co., Ltd.
Polishing composition: Colloidal silica slurry (the number average particle diameter of colloidal silica particles: 24 nm; concentration of colloidal silica particles: 8 wt %; medium: water; manufactured by Kao Corporation)
Preliminary polishing: load is 40 g/cm², time is 60 seconds, flow rate of polishing solution is 100 mL/min
Main polishing: load is 100 g/cm², time is 1200 seconds, flow rate of polishing solution is 100 mL/min
Water rinsing: load is 40 g/cm², time is 60 seconds, flow rate of rinsing water is about 2 L/min

(Cleaning)

Five sheets of soiled substrates to be cleaned were cleaned by using a cleaning apparatus under the conditions below. Respectively two sets of cleaning tanks and rinsing tanks were prepared.

(1) Cleaning-1: 450 g of a concentrated liquid of a detergent composition was diluted with ultrapure water to be 15000 g, thereby preparing a detergent composition (3 mass % dilution). This detergent composition was introduced into a cleaning tank (a). The liquid temperature inside the cleaning tank (a) was set to 40° C. Each of the substrates to be cleaned was immersed in the cleaning tank (a) and cleaned for 120 seconds while irradiating with ultrasonic wave (40 kHz).
(2) Rinsing-1: A rinsing tank (b) of ultrapure water was set to 40° C., into which the substrate to be cleaned was transferred from the cleaning tank (a) and immersed to be rinsed for 120 seconds while irradiating with ultrasonic wave (40 kHz).
(3) Steps (1) and (2) were repeated by using a cleaning tank (c) of a detergent composition prepared under the conditions similar to those for the cleaning tank (a) and a rinsing tank (d) of ultrapure water prepared under the conditions similar to those for the rinsing tank (b).
(4) Cleaning-2: The substrate to be cleaned was transferred from the interior of the rinsing tank into a scrub-cleaning unit (A) equipped with cleaning brushes. The detergent composition at 25° C. was injected toward the cleaning brushes and cleaning was conducted at 25° C. for 5 seconds by pressing the cleaning brushes onto the both surfaces of the substrate while rotating the brushes at 400 rpm under presence of the detergent composition. For the detergent composition, the same make-up as the detergent composition used in “(1) Cleaning-1” was used.
(5) Rinsing-2: The substrate to be cleaned was transferred into a scrub-cleaning unit (B), ultrapure water at 25° C. were injected, and rinsing was conducted at 25° C. for 5 seconds by pressing cleaning brushes onto the both surfaces of the substrate while rotating the brushes at 400 rpm.
(6) Steps (4) and (5) were repeated by using a scrub-cleaning unit (C) prepared under the conditions similar to those for the scrub-cleaning unit (A) and a scrub-cleaning unit (D) prepared under the conditions similar to those for the scrub-cleaning unit (B).
(7) Rinsing-3: The substrate to be cleaned was transferred into a rinsing tank (e) of ultrapure water and rinsed for 600 seconds at 25° C.
(8) Drying: The substrate to be cleaned was transferred into a rinsing tank (e) of warm pure water and immersed for 60 seconds. Thereafter, the substrate to be cleaned was pulled out from the water into the air at a rate of 90 mm/min, and the substrate surfaces were dried completely.

The ultrapure water was produced by using a continuous pure-water producing machine (Pure-conti PC-2000VR-L model) and Sub-system (Mac-Ace KC-05H model) both manufactured by Kurita Water Industries Ltd.

[Method for Measuring Surface Roughness]

From five substrates that had been subjected to the same polishing treatment obtained from the above-described polishing method, two substrates were selected at random. The substrates were cleaned using the detergent composition of the present invention so as to measure respective surface roughness. The surface roughness Ra was calculated by measuring both surfaces of each substrate under the conditions mentioned below using an AFM (Atomic Force Microscope: Digital Instrument NanoScope IIIa Multi Mode AFM) and averaging the values. These results are shown in Table 1 below.

### (Measurement Conditions of AFM)

Mode: Tapping mode

### Area: 1×1 μm

Scan rate: 1.0 Hz

### Cantilever: NCH-10V

### Line: 512×512

[Method for Measuring Cleaning Performance]

The cleaning performance was judged with reference to the etching amount of the silica particles. It can be considered that if the value is greater, the performance for cleaning the silica particles is better, namely for example, the performance to clean the silica particles used as the polishing agent is superior. The etching amount was measured under the conditions as described below. The etching amount in Comparative Example 1 was 19.9 ppm. The results are indicated in Table 1 below. The etching amounts indicated in Table 1 are values relative to the value of Comparative Example 1 set to be 100.

### (Method for Measuring Etching Amount of Silica Particles)

In a 100 ml container made of polypropylene, 0.1 g of silica powder (AEROSIL50 manufactured by Nippon Aerosil Co., Ltd.) was added to 20 g of detergent composition that had been obtained by diluting a concentrated liquid of the detergent composition with ultrapure water to 3 mass % (see Examples and Comparative Examples). Next, these were stirred for 15 minutes with a magnetic stirrer (rotator: 40 mm, peripheral speed: 1.5 m/s), the supernatant liquid was filtered with a filter (DISMIC-25HP020AN, bore diameter: 0.2 μm, manufactured by Advantec Co., Ltd.), and the supernatant liquid was used as the liquid specimen. With regard to the liquid specimen, Si emission intensity was measured by using an ICP emission spectrophotometer (Optima5300, manufactured by PerkinElmer, Inc.), and the Si concentration in the liquid specimen was quantified. A higher Si concentration in the liquid specimen indicates that the diluent has a higher capability of dissolving and removing silica fine particles (polishing material) adhering to the surface of the substrate surface to be cleaned.

TABLE 1

| | | | | | | | | | | | | Mass | | | | Cleaning |
|---|---|---|---|---|---|---|---|---|---|---|---|---|---|---|---|---|
| | | | | | | | Amine | | | | | Ratio | | Surface | Surface | property |
| | | Nonionic | Anionic | Chelating | | Potassium | | Number of | | | Alkali | of | | roughness | roughness | Etching |
| | | surfactant | polymer | agent | Solubilizer | hydroxide | | intramolecular | | Water | metal ion | amine/ | | before | after | amount |
| | | content* | content* | content* | content* | content | | N atoms | Content* | content | content | alkali | | cleaning | cleaning | (relative |
| | | (mass %) | (mass %) | (mass %) | (mass %) | (mass %) | Component | [number] | (mass %) | (mass %) | (mass %) | metal ion | pH** | Ra (A) | Ra (A) | value) |
| Ex- | 1 | 0.50 | 0.80 | 1.20 | 7.00 | 0.98 | 2-[(2-aminoethyl)amino]ethanol | 2 | 2.00 | 87.52 | 1.68 | 1.19 | 10.52 | 1.75 | 2.15 | 227 |
| ample | | 4.00 | 6.40 | 9.60 | 56.10 | 7.90 | | | 16.00 | | | | 10.66 | | | |
| | 2 | 0.50 | 0.80 | 1.20 | 7.00 | 0.98 | Diethylenetriamine | 3 | 2.00 | 87.52 | 1.68 | 1.19 | 10.57 | 1.75 | 2.09 | 210 |
| | | 4.00 | 6.40 | 9.60 | 56.10 | 7.90 | | | 16.00 | | | | 10.77 | | | |
| | 3 | 0.50 | 0.80 | 1.20 | 7.00 | 0.98 | Tetraethylenepentamine | 5 | 2.00 | 87.52 | 1.68 | 1.19 | 10.56 | 1.75 | 1.78 | 173 |
| | | 4.00 | 6.40 | 9.60 | 56.10 | 7.90 | | | 16.00 | | | | 10.78 | | | |
| | 4 | 0.50 | 0.80 | 1.20 | 7.00 | 0.98 | Pentaethylenehexamine | 6 | 2.00 | 87.52 | 1.68 | 1.19 | 10.29 | 1.75 | 1.77 | 150 |
| | | 4.00 | 6.40 | 9.60 | 56.10 | 7.00 | | | 16.00 | | | | 10.85 | | | |
| | 5 | 0.50 | 0.80 | 1.20 | 7.00 | 0.98 | 1-(2-hydroxyethyl)piperazine | 2 | 2.00 | 87.52 | 1.68 | 1.19 | 10.30 | 1.75 | 1.80 | 120 |
| | | 4.00 | 6.40 | 9.60 | 56.10 | 7.90 | | | 16.00 | | | | 10.60 | | | |
| | 6 | 0.50 | 0.80 | 1.20 | 7.00 | 0.98 | 2-[(2-aminoethyl)amino]ethanol | 2 | 1.00 | 88.52 | 1.68 | 0.60 | 10.16 | 1.75 | 2.20 | 200 |
| | | 4.40 | 7.00 | 10.50 | 61.00 | 8.50 | | | 8.70 | | | | 10.60 | | | |
| | 7 | 0.50 | 0.80 | 1.20 | 7.00 | 0.98 | 2-[(2-aminoethyl)amino]ethanol | 2 | 8.00 | 81.52 | 1.68 | 4.76 | 11.07 | 1.75 | 2.37 | 232 |
| | | 2.70 | 4.30 | 6.50 | 37.90 | 5.30 | | | 43.30 | | | | 10.95 | | | |
| | 8 | 0.50 | 0.80 | 1.20 | 7.00 | 0.98 | 2-[(2-aminoethyl)amino]ethanol | 2 | 10.00 | 79.52 | 1.68 | 5.95 | 11.17 | 1.75 | 2.46 | 255 |
| | | 2.40 | 3.90 | 5.90 | 34.20 | 4.80 | | | 48.80 | | | | 10.99 | | | |
| | 9 | 0.50 | 0.80 | 1.20 | 7.00 | 0.98 | 2-[(2-aminoethyl)amino]ethanol | 2 | 20.00 | 69.52 | 1.68 | 11.90 | 11.54 | 1.75 | 2.65 | 270 |
| | | 1.60 | 2.60 | 3.90 | 23.00 | 3.20 | | | 65.60 | | | | 11.14 | | | |
| | 10 | 0.50 | 0.80 | 1.20 | 7.00 | 0.07 | 2-[(2-aminoethyl)amino]ethanol | 2 | 2.00 | 88.43 | 1.05 | 1.90 | 9.00 | 1.75 | 1.76 | 124 |
| | | 4.30 | 6.90 | 10.40 | 60.50 | 0.60 | | | 17.30 | | | | 9.14 | | | |
| | 11 | 0.50 | 0.80 | 1.20 | 7.00 | 1.43 | 2-[(2-aminoethyl)amino]ethanol | 2 | 2.00 | 87.07 | 1.99 | 1.01 | 12.00 | 1.75 | 2.73 | 300 |
| | | 3.90 | 6.20 | 9.30 | 54.10 | 11.10 | | | 15.50 | | | | 11.28 | | | |
| | 12 | 0.50 | 0.80 | 1.20 | 7.00 | 0.98 | Monoethanolanine | 1 | 2.00 | 87.52 | 1.68 | 1.19 | 10.60 | 1.75 | 2.10 | 215 |
| | | 4.00 | 6.40 | 9.80 | 56.10 | 7.90 | | | 16.00 | | | | 10.56 | | | |
| Com- | 1 | 0.50 | 0.80 | 1.20 | 7.00 | 1.20 | — | — | — | 89.30 | 1.84 | 0.00 | 10.18 | 1.75 | 2.79 | 100 |
| para- | | 4.70 | 7.50 | 11.20 | 65.40 | 11.20 | | | | | | | 10.78 | | | |
| tive | 2 | 0.50 | 0.80 | 1.20 | 7.00 | 1.20 | 2-[(2-aminoethyl)amino]ethanol | 2 | 0.10 | 89.20 | 1.84 | 0.05 | 10.20 | 1.75 | 2.79 | 108 |
| Ex- | | 4.60 | 7.40 | 11.10 | 64.80 | 11.10 | | | 0.90 | | | | 10.81 | | | |
| ample | 3 | 0.50 | 0.80 | 1.20 | 7.00 | 4.80 | Methyldiethanolamine | 1 | 2.00 | 83.70 | 4.34 | 0.46 | 13.59 | 1.75 | 3.40 | 453 |
| | | 3.10 | 4.90 | 7.40 | 42.90 | 29.40 | | | 12.27 | | | | 12.13 | | | |
| | 4 | 0.50 | 0.80 | 1.20 | 7.00 | 0.98 | Polyamine (Mw600) | 14 | 2.00 | 87.52 | 1.68 | 1.19 | 10.52 | 1.75 | 2.40 | 95 |
| | | 4.00 | 6.40 | 9.60 | 56.10 | 7.90 | | | 16.00 | | | | 10.77 | | | |
| | 5 | 0.50 | 0.80 | 1.20 | 7.00 | 0.00 | 2-[(2-aminoethyl)amino]ethanol | 2 | 2.00 | 88.50 | 1.00 | 2.00 | 8.72 | 1.75 | 1.76 | 90 |
| | | 4.30 | 7.00 | 10.40 | 60.90 | 0.00 | | | 17.40 | | | | 8.78 | | | |
| | 6 | 0.50 | 0.80 | 1.20 | 7.00 | 3.89 | 2-[(2-aminoethyl)amino]ethanol | 2 | 2.00 | 84.61 | 3.71 | 0.54 | 13.14 | 1.75 | 3.32 | 413 |
| | | 3.20 | 5.20 | 7.80 | 45.50 | 25.80 | | | 13.00 | | | | 12.04 | | | |
| | 7 | 0.50 | 0.80 | 1.20 | 7.00 | 3.89 | 2-[(2-aminoethyl)amino]ethanol | 2 | 5.00 | 81.61 | 3.71 | 1.35 | 13.31 | 1.75 | 3.35 | 449 |
| | | 2.70 | 4.40 | 6.50 | 38.10 | 21.20 | | | 27.20 | | | | 12.07 | | | |
| Refer- | 1 | 0.50 | 0.80 | 1.20 | 7.00 | 1.20 | — | — | — | 89.30 | 1.84 | 0.00 | 10.18 | 0.90 | 1.13 | 100 |
| ence | | 4.70 | 7.50 | 11.20 | 65.40 | 11.20 | | | | | | | 10.78 | | | |
| Ex- | 2 | 0.50 | 0.80 | 1.20 | 7.00 | 0.98 | 2-[(2-aminoethyl)amino]ethanol | 2 | 2.00 | 87.52 | 1.68 | 1.19 | 10.52 | 0.90 | 1.23 | 227 |
| ample | | 4.00 | 6.40 | 9.60 | 58.10 | 7.90 | | | 16.00 | | | | 10.66 | | | |

*Each content in the upper column refers to the mass components including water; each content in the lower column refers to the mass components other than water.
**Regarding pH, the upper column refers to a concentrated liquid; the lower column refers to a pH in use (3% diluent of concentrated liquid).

As shown in the above Table 1, in cleaning the crystallized glass substrates, Examples 1-12 exhibited excellent cleaning performance with suppressed aggravation in the surface roughness after cleaning, when compared with Comparative Examples 1-7. On the other hand, according to a comparison between Reference Examples 1 and 2, it is evident that an amorphous glass substrate does not exhibit an effect of suppressing aggravation of surface roughness even by blending the amine similar to that of Example 1.

1. A method for producing a glass hard disk substrate, comprising steps (1) and (2) below:
step (1) of polishing a glass substrate to be polished by use of a polishing liquid composition; and
step (2) of cleaning the substrate obtained in step (1) by use of a detergent composition,
wherein the detergent composition contains an amine including 1 to 10 nitrogen atoms and an inorganic alkali,
a content of the amine is in a range of 5.00 mass % to 70.00 mass % relative to the total mass of components of the detergent composition other than water,
a mass ratio of the amine to an alkali metal ion derived from the inorganic alkali [(content of amine)/(content of alkali metal ion)] is in a range of 0.50 to 12.00,
the glass substrate to be cleaned is a crystallized glass substrate, and
a pH of the detergent during cleaning is in a range of 9.00 to 11.50.

2. The method for producing a glass hard disk substrate according to claim 1, wherein the detergent composition is a polishing liquid composition including silica particles.

3. (canceled)

4. The method for producing a glass hard disk substrate according to claim 1, wherein the amine is at least one selected from the group consisting of a compound represented by General Formula (I), alkanolamine, and a compound having a piperazine ring: 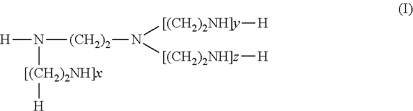
wherein x, y and z respectively denote integers in a range of 0 to 4, satisfying 1≦x+y+z≦4.

5. The method for producing a glass hard disk substrate according to claim 1, wherein the amine is at least one selected from the group consisting of: tetraethylenepentamine, pentaethylenehexamine, monoethanolamine, 2-[(2-aminoethyl)amino]ethanol, and 1-(2-hydroxyethyl)piperazine.

6. The method for producing a glass hard disk substrate according to claim 1, wherein the detergent composition contains further a nonionic surfactant represented by General Formula (II) below:
R—O-(EO)o(PO)p-H (II)
wherein R is a linear or branched alkyl group having 6-16 carbon atoms, o is an average number of added moles of EO, and p is an average number of added moles of PO; o is a number in a range of 0 to 20, and p is a number in a range of 0 to 5.

7. The method for producing a glass hard disk substrate according to claim 6, wherein a content of the nonionic surfactant is in a range of 1.00 mass % to 5.00 mass % relative to the total mass of the components other than water.

8. The method for producing a glass hard disk substrate according to claim 1, wherein the detergent composition further contains at least one solubilizer selected from the group consisting of p-toluenesulfonic acid, dimethylbenzenesulfonic acid, 2-ethylhexanoic acid and salts thereof.

9. The method for producing a glass hard disk substrate according to claim 8, wherein a content of the solubilizer is in a range of 20.00 mass % to 62.00 mass % relative to the total mass of the components other than water.

10. The method for producing a glass hard disk substrate according to claim 1, wherein the detergent composition contains further an anionic polymer.

11. The method for producing a glass hard disk substrate according to claim 10, wherein a content of the anionic polymer is in a range of 2.50 mass % to 7.50 mass % relative to the total mass of the components other than water.

12. The method for producing a glass hard disk substrate according to claim 1, wherein the detergent composition contains further a chelating agent.

13. The method for producing a glass hard disk substrate according to claim 12, wherein a content of the chelating agent is in a range of 3.80 mass % to 10.60 mass % relative to the total mass of the components other than water.

14. The method for producing a glass hard disk substrate according to claim 1, comprising diluting a concentrated liquid of the detergent composition containing water in a range of 60.00 mass % to 95.00 mass %.

15. A method for cleaning a glass substrate, comprising a step of bringing a detergent composition into contact with a glass substrate to be cleaned,
wherein the detergent composition contains an amine including 1 to 10 nitrogen atoms and an inorganic alkali,
a content of the amine is in a range of 5.00 mass % to 70.00 mass % relative to the total mass of components of the detergent composition other than water,
a mass ratio of the amine to an alkali metal ion derived from the inorganic alkali [(content of amine)/(content of alkali metal ion)] is in a range of 0.50 to 12.00,
the glass substrate to be cleaned is a crystallized glass substrate, and
a pH of the detergent composition during cleaning is in a range of 9.00 to 11.50.

16. The method for cleaning a glass substrate according to claim 15, wherein the glass substrate to be cleaned is a substrate obtained by subjecting a glass substrate to be polished to a polishing with silica particles.

17. (canceled)

18. The method for cleaning a glass substrate according to claim 15, wherein the amine is at least one selected from the group consisting of a compound represented by General Formula (I), alkanolamine, and a compound having a piperazine ring: 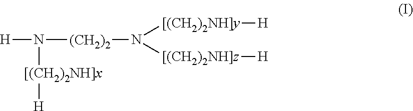
wherein x, y and z respectively denote integers in a range of 0 to 4, satisfying 1≦x+y+z≦4.

19. The method for cleaning a glass substrate according to claim 15, comprising diluting a concentrated liquid of the detergent composition containing water in a range of 60 mass % to 95 mass %.

20. The method for cleaning a glass substrate according to claim 15, wherein the glass substrate to be cleaned is a glass substrate for a glass hard disk substrate.
